(19) United States
(12) Patent Application Publication
(10) Pub. No.: US 2024/0221559 A1
(43) Pub. Date: Jul. 4, 2024

(54) DISPLAY DEVICE AND DRIVING METHOD

(71) Applicant: LG Display Co., Ltd., Seoul (KR)

(72) Inventors: Byungjae LEE, Incheon (KR); Jin-Hyun JUNG, Seoul (KR); Changwoo LEE, Paju-si (KR); Yumin HONG, Paju-si (KR)

(21) Appl. No.: 18/517,052

(22) Filed: Nov. 22, 2023

(30) Foreign Application Priority Data
Dec. 30, 2022 (KR) 10-2022-0190565

(51) Int. Cl. G09G 3/00; G09G 3/20; G09G 3/3233

(52) U.S. Cl. CPC G09G 3/006; G09G 3/2096; G09G 3/3233; G09G 2300/0842; G09G 2310/027; G09G 2310/0297; G09G 2310/08; G09G 2330/021; G09G 2330/12; G09G 2370/08

(57) ABSTRACT

Embodiments of the present disclosure relate to a display device and a driving method. A data driving circuit transmits feedback data generated on the basis of input data to a controller, and the controller generates corrected data by comparing the input data and the feedback data. It is possible to automatically detect noise, and it is possible to detect noise in real time.

### CROSS-REFERENCE TO RELATED APPLICATION

This application claims priority from Korean Patent Application No. 10-2022-0190565, filed on Dec. 30, 2022, which is hereby incorporated by reference for all purposes as if fully set forth herein.

### BACKGROUND

### Technical Field

Embodiments of the present disclosure relate to a display device and a driving method.

### Description of the Related Art

As the information society develops, demands for display devices for displaying an image are increasing in various forms. Recently, various display devices such as a liquid crystal display device and an organic light emitting display device have been used.

A display device may include a display panel in which a plurality of data lines, a plurality of gate lines and a plurality of subpixels are disposed, a data driving circuit which outputs data signals to the plurality of data lines, and a gate driving circuit which outputs scan signals to the plurality of gate lines.

### BRIEF SUMMARY

The inventors of the present disclosure have recognized that the data driving circuit and a controller in the related art may be influenced by noise. In particular, when influence by noise is exerted on a display device using the current embedded point-to-point interface (EPI) standard, a technical problem may arise in that there is no method for detecting noise or no solution for noise.

Various embodiments of the present disclosure are directed to providing a display device and a driving method capable of automatically detecting noise.

Various embodiments of the present disclosure are directed to providing a display device and a driving method capable of detecting noise in real time.

Various embodiments of the present disclosure are directed to providing a display device and a driving method capable of low power consumption driving by detecting noise in real time.

Embodiments of the present disclosure may provide a display device including: a display panel including a plurality of subpixels which are electrically connected to a plurality of data lines and a plurality of gate lines; a data driving circuit for supplying data voltages to the plurality of subpixels; and a controller configured to transmit input data to the data driving circuit, wherein the data driving circuit transmits feedback data generated on the basis of the input data to the controller, and wherein the controller generates corrected data by comparing the input data and the feedback data.

Embodiments of the present disclosure may provide a method for driving a display device, including: selected data transmission step in which a controller for controlling a data driving circuit transmits input data to the data driving circuit; feedback data generation step in which the data driving circuit generates feedback data on the basis of the input data; feedback data transmission step in which the data driving circuit transmits the feedback data to the controller; data error checking step in which the controller compares the input data and the feedback data; and data correction step in which, when determining that an error has occurred in the feedback data, the controller generates corrected data by correcting the input data.

According to the embodiments of the present disclosure, it is possible to provide a display device and a driving method capable of automatically detecting noise.

According to the embodiments of the present disclosure, it is possible to provide a display device and a driving method capable of detecting noise in real time.

According to the embodiments of the present disclosure, it is possible to provide a display device and a driving method capable of low power consumption driving by detecting noise in real time.

### BRIEF DESCRIPTION OF THE SEVERAL VIEWS OF THE DRAWINGS

The above and other objects, features, and advantages of the present disclosure will be more clearly understood from the following detailed description, taken in conjunction with the accompanying drawings, in which:

FIG. 1 is a diagram illustrating the schematic configuration of a display device in accordance with embodiments of the present disclosure;

FIG. 2 is a system diagram of a display device in accordance with embodiments of the present disclosure;

FIG. 3 is a diagram illustrating the structure of a point-to-point interface in a display device in accordance with embodiments of the present disclosure;

FIG. 4 is a diagram illustrating an example of waveforms of signals transferred in the point-to-point interface;

FIG. 5 is a diagram illustrating a data driving circuit and a controller in accordance with embodiments of the present disclosure;

FIG. 6 is a diagram schematically illustrating a data driving circuit and a controller in accordance with embodiments of the present disclosure;

FIG. 7 is a circuit block diagram of a data driving circuit and a controller in accordance with embodiments of the present disclosure;

FIG. 8 is a flowchart in which a test mode in accordance with embodiments of the present disclosure is driven;

FIGS. 9, 10, and 11 are diagrams for explaining data error checking step and data correction step performed in the test mode in accordance with the embodiments of the present disclosure;

FIG. 12 is a flowchart in which a real time mode in accordance with embodiments of the present disclosure is driven; and

FIGS. 13 and 14 are diagrams for explaining driving of the real time mode in accordance with the embodiments of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including.” “having,” “containing,” “constituting” “make up of,” and “formed of”' used herein are generally intended to allow other components to be added unless the terms are used with the term “only.” As used herein, singular forms are intended to include plural forms unless the context clearly indicates otherwise.

Terms, such as “first,” “second,” “A,” “B,” “(A),” or “(B)” may be used herein to describe elements of the present disclosure. Each of these terms is not used to define essence, order, sequence, or number of elements etc., but is used merely to distinguish the corresponding element from other elements.

When it is mentioned that a first element “is connected or coupled to,” “contacts or overlaps.” etc., a second element, it should be interpreted that, not only can the first element “be directly connected or coupled to” or “directly contact or overlap” the second element, but a third element can also be “interposed” between the first and second elements, or the first and second elements can “be connected or coupled to,” “contact or overlap,” etc., each other via a fourth element. Here, the second element may be included in at least one of two or more elements that “are connected or coupled to,” “contact or overlap,” etc., each other.

When time relative terms, such as “after.” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes, etc., are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can.”

Hereinafter, various embodiments of the present disclosure will be described in detail with reference to accompanying drawings.

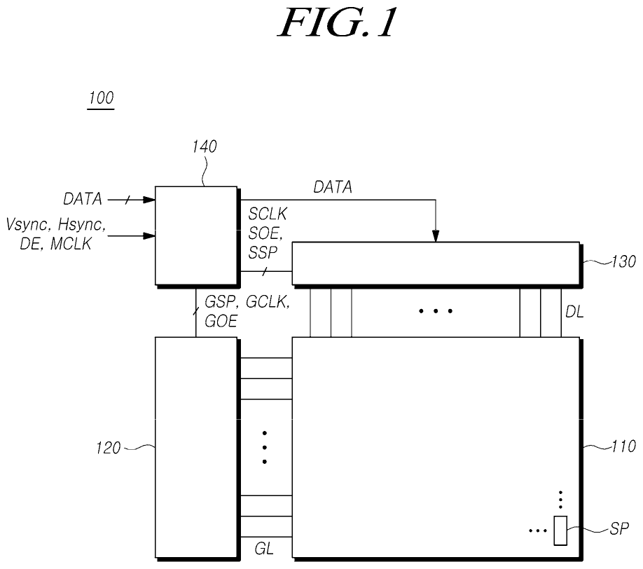

FIG. 1 is a diagram illustrating the schematic configuration of a display device 100 in accordance with embodiments of the present disclosure.

Referring to FIG. 1, the display device 100 in accordance with the embodiments of the present disclosure may include a display panel 110 in which a plurality of gate lines GL and a plurality of data lines DL are connected and a plurality of subpixels SP are arranged in a matrix form, a gate driving circuit 120 which drives the plurality of gate lines GL, a data driving circuit 130 which supplies data voltages through the plurality of data lines DL, and a controller 140 which controls the gate driving circuit 120 and the data driving circuit 130.

The display panel 110 may display an image on the basis of scan signals transferred through the plurality of gate lines GL from the gate driving circuit 120 and data voltages transferred through the plurality of data lines DL from the data driving circuit 130.

In the case of a liquid crystal display, the display panel 110 may include a liquid crystal layer formed between two substrates, and may operate in any known mode such as a twisted nematic (TN) mode, a vertical alignment (VA) mode, an in-plane switching (IPS) mode and a fringe field switching (FFS) mode. On the other hand, in the case of an organic light emitting display, the display panel 110 may be implemented in a top emission type, a bottom emission type or a dual emission type.

In the display panel 110, a plurality of pixels may be arranged in a matrix form, each pixel may be composed of subpixels SP of different colors, for example, a white subpixel, a red subpixel, a green subpixel and a blue subpixel, and respective subpixels SP may be defined by the plurality of data lines DL and the plurality of gate lines GL.

One subpixel SP may include a thin film transistor (TFT) which is formed in an area where one data line DL and one gate line GL intersect, a light emitting element, such as an organic light emitting diode, which charges a data voltage, and a storage capacitor which is electrically connected to the light emitting element to maintain a voltage.

For example, when the display device 100 having a resolution of 2,160×3,840 includes four subpixels SP of white (W), red (R), green (G) and blue (B), 2,160 gate lines GL and a total of 3,840×4=15,360 data lines DL by 3,840 data lines DL each connected to the four subpixels (WRGB) may be provided, and subpixels SP may be disposed at points, respectively, where the gate lines GL and the data lines DL intersect.

The gate driving circuit 120 may be controlled by the controller 140, and may control driving timings for the plurality of subpixels SP by sequentially outputting scan signals to the plurality of gate lines GL disposed in the display panel 110.

In the display device 100 having the resolution of 2,160×3,840, a case where scan signals are sequentially outputted to a first gate line to a 2,160th gate line for the 2,160 gate lines GL may be referred to as 2,160 phase driving. Alternatively, as in a case where scan signals are sequentially outputted to a first gate line to a fourth gate line and then scan signals are sequentially outputted to a fifth gate line to an eighth gate line, a case where scan signals are sequentially outputted in the units of four gate lines GL may be referred to as 4 phase driving. That is to say, a case where scan signals are sequentially outputted to every N number of gate lines GL may be referred to as N phase driving.

The gate driving circuit 120 may include at least one gate driving integrated circuit (GDIC), and may be located on only one side or both sides of the display panel 110 depending on a driving scheme. Alternatively, the gate driving circuit 120 may be built in the bezel area of the display panel 110 to be implemented in a gate-in-panel (GIP) type.

The data driving circuit 130 may receive image data DATA from the controller 140, and may convert the received image data DATA into data voltages of an analog type. Then, by outputting a data voltage to each data line DL in conformity with a timing at which a scan signal is applied through a gate line GL, the subpixel SP connected to the data line DL may emit light with a luminance corresponding to the data voltage.

Similarly, the data driving circuit 130 may include at least one source driving integrated circuit (SDIC), and the source driving integrated circuit (SDIC) may be connected to bonding pads of the display panel 110 or be directly disposed on the display panel 110 in a tape automated bonding (TAB) type or a chip-on-glass (COG) type.

As the case may be, each source driving integrated circuit (SDIC) may be disposed in the display panel 110 by being integrated thereinto. Alternatively, each source driving integrated circuit (SDIC) may be implemented in a chip-on-film (COF) type. In this case, each source driving integrated circuit (SDIC) may be mounted on a circuit film, and may be electrically connected to the data lines DL of the display panel 110 through the circuit film.

The controller 140 may supply various control signals to the gate driving circuit 120 and the data driving circuit 130, and may control operations of the gate driving circuit 120 and the data driving circuit 130. In other words, the controller 140 may control the gate driving circuit 120 to output a scan signal according to a timing implemented in each frame, and on the other hand, may transfer the image data DATA received from the outside to the data driving circuit 130.

Along with the image data DATA, the controller 140 may receive various timing signals, including a vertical synchronization signal Vsync, a horizontal synchronization signal Hsync, a data enable signal DE and a main clock signal MCLK, from the outside (e.g., a host system). Accordingly, the controller 140 may generate control signals using the various timing signals received from the outside, and may transfer the control signals to the gate driving circuit 120 and the data driving circuit 130.

For example, in order to control the gate driving circuit 120, the controller 140 may output various gate control signals including a gate start pulse GSP, a gate clock GCLK and a gate output enable signal GOE. The gate start pulse GSP may control a timing at which the at least one gate driving integrated circuit (GDIC) constituting the gate driving circuit 120 starts an operation. The gate clock GCLK, as a clock signal which is inputted in common to the at least one gate driving integrated circuit (GDIC), may control the shift timing of a scan signal. The gate output enable signal GOE may designate the timing information of the at least one gate driving integrated circuit (GDIC).

Further, in order to control the data driving circuit 130, the controller 140 may output various data control signals including a source start pulse SSP, a source sampling clock SCLK and a source output enable signal SOE. The source start pulse SSP may control a timing at which the at least one source driving integrated circuit (SDIC) constituting the data driving circuit 130 starts a data sampling. The source sampling clock SCLK is a clock signal which controls a timing for sampling data in the source driving integrated circuit (SDIC). The source output enable signal SOE may control the output timing of the data driving circuit 130.

The display device 100 may further include a power management integrated circuit which supplies various voltages or currents to the display panel 110, the gate driving circuit 120 and the data driving circuit 130 or controls various voltages or currents to be supplied.

Each subpixel SP may be located at a point where the gate line GL and the data line DL intersect, and a light emitting element may be disposed in each subpixel SP. For example, an organic light emitting display device may include a light emitting element such as an organic light emitting diode (OLED) in each subpixel SP, and may display an image by controlling a current flowing through the light emitting element according to a data voltage.

The display device 100 may be various types of devices such as a liquid crystal display, an organic light emitting display and a plasma display panel.

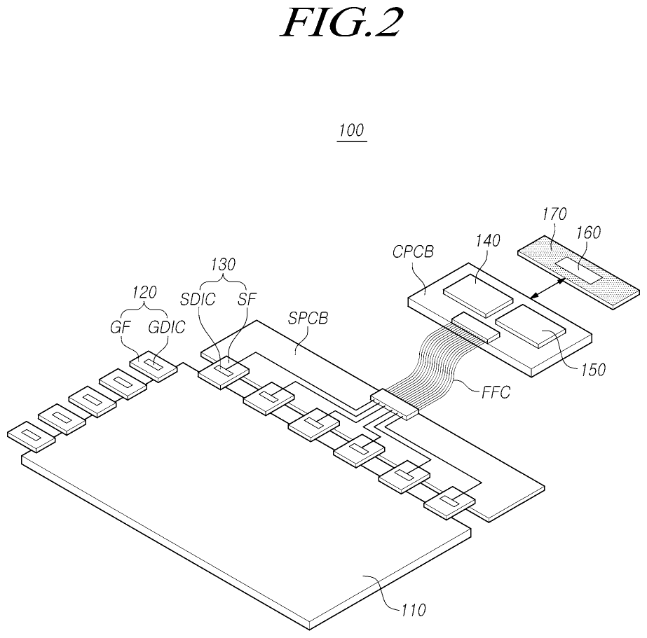

FIG. 2 is a system diagram of a display device 100 in accordance with embodiments of the present disclosure.

Referring to FIG. 2, the display device 100 in accordance with the embodiments of the present disclosure illustrates a case where a source driving integrated circuit SDIC included in a data driving circuit 130 is implemented in a chip-on-film (COF) type among various types such as TAB, COG and COF types and the gate driving circuit 120 is implemented in a gate-in-panel (GIP) type among various types such as TAB, COG, COF and GIP types.

Each of one or more gate driving integrated circuits GDIC included in a gate driving circuit 120 may be mounted on a gate film GF, and one end of the gate film GF may be electrically connected to a display panel 110. Lines for electrically connecting the gate driving integrated circuit GDIC and the display panel 110 may be disposed on the gate film GF.

Similarly, each of one or more source driving integrated circuits SDIC included in a data driving circuit 130 may be mounted on a source film SF, and one end of the source film SF may be electrically connected to the display panel 110. Lines for electrically connecting the source driving integrated circuit SDIC and the display panel 110 may be disposed on the source film SF.

In order for circuit connection between the plurality of source driving integrated circuits SDIC and other devices, the display device 100 may include at least one source printed circuit board SPCB and a control printed circuit board CPCB for mounting control parts and various electric devices.

The other end of the source film SF on which the source driving integrated circuit SDIC is mounted may be connected to the at least one source printed circuit board SPCB. Namely, one end of the source film SF on which the source driving integrated circuit SDIC is mounted may be electrically connected to the display panel 110, and the other end of the source film SF may be electrically connected to the source printed circuit board SPCB.

A controller 140 and a power management integrated circuit (PMIC) 150 may be mounted on the control printed circuit board CPCB. The controller 140 may control operations of the data driving circuit 130 and the gate driving circuit 120. The power management integrated circuit 150 may supply driving voltages or currents to the display panel 110, the data driving circuit 130 and the gate driving circuit 120, or may control voltages or currents to be supplied.

The at least one source printed circuit board SPCB and the control printed circuit board CPCB may be connected in terms of circuit by at least one connection member. The connection member may be, for example, a flexible printed circuit (FPC) or a flexible flat cable FFC. The connection member which connects the at least one source printed circuit board SPCB and the control printed circuit board CPCB may be variously changed depending on a size and type of the display device 100. The at least one source printed circuit board SPCB and the control printed circuit board CPCB may be implemented by being integrated into a single printed circuit board.

The display device 100 may further include a set board 170 which is electrically connected to the control printed circuit board CPCB. The set board 170 may also be referred to as a power board. A main power management circuit (M-PMC) 160 which manages total power of the display device 100 may exist on the set board 170. The main power management circuit 160 may interoperate with the power management integrated circuit 150.

In the case of the display device 100 configured as mentioned above, a driving voltage may be generated in the set board 170 and be transferred to the power management integrated circuit 150 on the control printed circuit board CPCB. The power management integrated circuit 150 may transfer a driving voltage necessary for display driving or characteristic value sensing to the source printed circuit board SPCB through the flexible printed circuit (FPC) or the flexible flat cable FFC. The driving voltage transferred to the source printed circuit board SPCB may be supplied through the source driving integrated circuit SDIC to cause light emission or sense a specific subpixel SP in the display panel 110.

Each subpixel SP arranged in the display panel 110 of the display device 100 may be constituted by circuit elements such as an organic light emitting diode (OLED) as a light emitting element and a driving transistor for driving the organic light emitting diode (OLED).

The type and number of circuit elements constituting each subpixel SP may be determined in a variety of ways depending on a function to be provided and a design scheme.

In order to minimize the number of signal lines which connect the controller 140 mounted on the control printed circuit board CPCB and the data driving circuit 130 mounted on the source printed circuit board SPCB and stabilize signal transmission, the display device 100 of the present disclosure may use a point-to-point interface which serializes image data DATA, converts the image data DATA into packet units by inserting clock information and transmits packets.

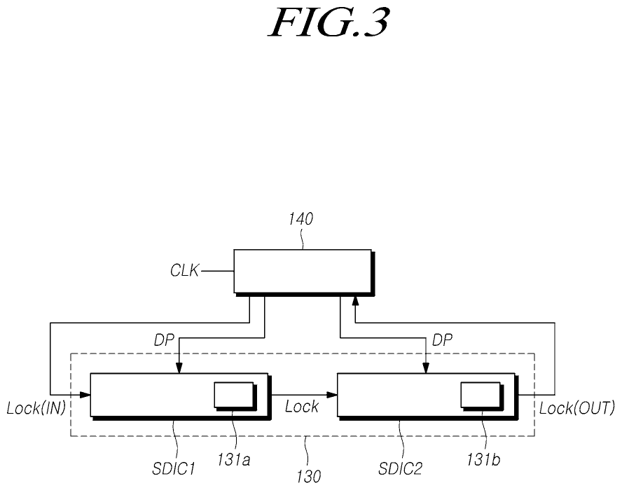

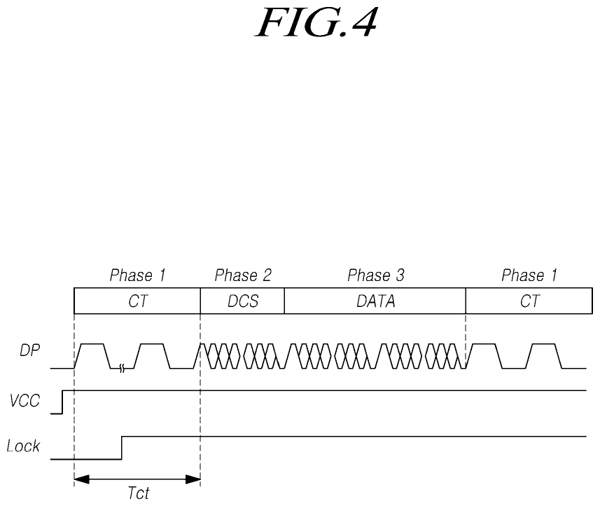

FIG. 3 is a diagram illustrating the structure of a point-to-point interface in a display device 100 in accordance with embodiments of the present disclosure, and FIG. 4 is a diagram illustrating an example of waveforms of signals transferred in the point-to-point interface.

Referring to FIGS. 3 and 4, the display device 100 in accordance with the embodiments of the present disclosure may include a controller 140 which transmits a plurality of data packets DP and a data driving circuit 130 which receives the plurality of data packets DP transmitted from the controller 140.

An interface standard exemplified herein may be an embedded point-to-point interface (EPI) which, in order to reduce the number of data transmission lines between the controller 140 and the data driving circuit 130 and enable high-speed transmission, serializes a data control signal DCS and image data DATA, converts the serialized data control signal DCS and image data DATA into packet units by inserting clock information and transmits data packets DP in a point-to-point type.

Also, herein, a structure in which the controller 140 transmits data packets DP and the data driving circuit 130 including two source driving integrated circuits SDIC1 and SDIC2 receives the data packets DP and supplies the data packets DP to a display panel 110 is described as an example.

The controller 140 may transmit in series a plurality of data packets DP to the data driving circuit 130 according to a clock signal CLK.

The data packet DP transmitted by the controller 140 may be divided into a first transmission time Phase 1, a second transmission time Phase 2 and a third transmission time Phase 3.

In the first transmission time Phase 1, clock training for synchronizing the clock signal CLK may be performed using a clock training pattern CT.

In the second transmission time Phase 2, the data control signal DCS for controlling the data driving circuit 130 may be transmitted.

In the third transmission time Phase 3, the image data DATA may be transmitted.

Times in which the data packet DP is transmitted and types of data to be transmitted may be changed in a variety of ways.

In a horizontal blank time or a vertical blank time, the controller 140 may synchronize the clock signal CLK by performing clock training with the data driving circuit 130 during a clock training time Tct.

In a state in which the controller 140 is synchronized with the data driving circuit 130 through clock training, the controller 140 may transmit a lock input signal Lock(IN) to the data driving circuit 130. The controller 140 may be fed back with a lock output signal Lock(OUT) from the data driving circuit 130.

When the phase of an internal clock signal is fixed, the first source driving integrated circuit SDIC1 may generate a lock signal Lock of a high logic level indicating a stable output state, and may transfer the lock signal Lock to the adjacent second source driving integrated circuit SDIC2. The lock signal Lock generated by a last source driving integrated circuit (SDIC2 herein) of the data driving circuit 130 becomes the lock output signal Lock(OUT) of the data driving circuit 130, and the lock output signal Lock(OUT) is transmitted to the controller 140 through a signal line connected between the controller 140 and the last source driving integrated circuit SDIC2. A DC power supply voltage VCC of a high level may be inputted to input terminals of the source driving integrated circuits SDIC1 and SDIC2 to which the lock signals Lock(IN) and Lock are inputted.

When the lock output signal Lock(OUT) which is normal is received from the data driving circuit 130, the controller 140 may transmit corresponding data packets DP to the plurality of source driving integrated circuits SDIC1 and SDIC2 constituting the data driving circuit 130.

In order to reduce the number of transmission lines, the embedded point-to-point interface (EPI) standard may not use a line for transmitting the clock signal CLK between the controller 140 and the data driving circuit 130. In this case, when the controller 140 transmits the data packets DP, the data driving circuit 130 may generate internal clock signals in clock recovery circuits 131a and 131b using the received data packets DP, and may transfer the image data DATA in correspondence to the generated internal clock signals.

The data driving circuit 130 may compare the internal clock signals generated by the clock recovery circuits 131a and 131b with a clock training pattern transmitted from the controller 140, and when there is no abnormality as a result of the comparison, may transmit the lock output signal Lock(OUT) of a high level to the controller 140.

The lock output signal Lock(OUT) transmitted from the data driving circuit 130 to the controller 140 may be a signal obtained by feeding back the lock input signal Lock(IN) transmitted from the controller 140 to the data driving circuit 130.

In a state in which the lock output signal Lock(OUT) is transmitted to the controller 140, since the data driving circuit 130 may fix the phases and frequencies of the data packets DP synchronized through clock training, the data driving circuit 130 may be in a state capable of receiving the data packets DP transmitted from the controller 140.

In the case where the point-to-point interface is used, the controller 140 may control output characteristics of the data packets DP to be transmitted, depending on a connection state with the data driving circuit 130 or signal transfer characteristics. In particular, since the length of a cable (e.g., an FFC) which connects the controller 140 and the data driving circuit 130 varies depending on the size and type of the display device 100, the output characteristics of the data packets DP may be controlled in consideration of a signal delay occurring between the controller 140 and the data driving circuit 130 due to a variation in the length of the cable.

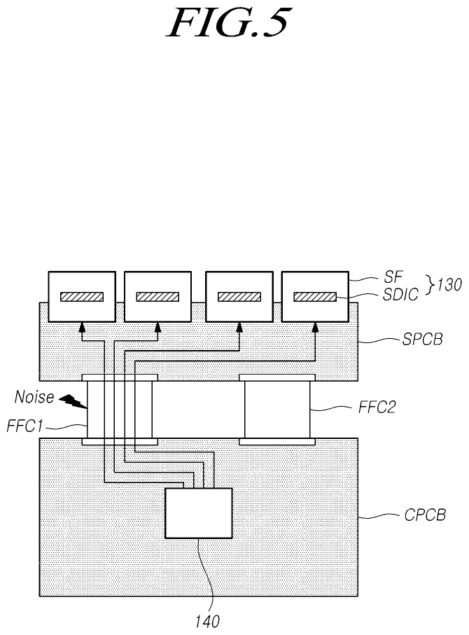

FIG. 5 is a diagram illustrating a data driving circuit 130 and a controller 140 in accordance with embodiments of the present disclosure.

The data driving circuit 130 and the controller 140 illustrated in FIG. 5 may be the same as the data driving circuit 130 and the controller 140 illustrated in FIG. 2.

Referring to FIG. 5, the data driving circuit 130 may be electrically connected to the controller 140 through cables FFC1 and FFC2 and printed circuit boards SPCB and CPCB. Accordingly, the data driving circuit 130 may receive signals from the controller 140.

The data packet DP shown in FIG. 4 may be transmitted from the controller 140 to the data driving circuit 130. The data driving circuit 130 may include a plurality of source driving integrated circuits SDIC. For example, referring to FIG. 5, the data driving circuit 130 may include four source driving integrated circuits SDIC. Data packets DP may be transmitted to the four source driving integrated circuits SDIC.

The data driving circuit 130 and the controller 140 may be affected by noise. Noise may include various noise generally occurring in an electronic device. For example, noise may occur by signal interference caused by the surrounding environment of the display device 100, the margin ratio of a printed circuit board (PCB), signal interference between lines to which signals are supplied, etc. That is to say, there is no limitation in causes by which noise occurs.

The data packet DP may be composed of a plurality of bits. Each of the plurality of bits is a minimum unit of information amount, and may be expressed in binary. In other words, each of the plurality of bits may have a bit value of 0 or a bit value of 1. When the data driving circuit 130 and the controller 140 are affected by noise, some bits among the plurality of bits included in the data packet DP may vary in their bit values during a transmission process. A case where a variation occurs in the value of a bit included in the data packet DP may be referred to as a case where an error occurs in the data packet DP.

For example, the controller 140 may transmit the data packet DP including a first bit having the bit value of 1 to the data driving circuit 130. However, due to the influence of noise, the first bit included in the data packet DP may vary from the bit value of 1 to the bit value of 0 during a transmission process. Namely, although the controller 140 transmits the data packet DP including the first bit having the bit value of 1 to the data driving circuit 130, the data driving circuit 130 may receive the data packet DP whose first bit has varied to the bit value of 0. That is to say, as a bit value included in the data packet DP varies during a transmission process, the display device 100 may abnormally operate or the control of the display device 100 may not be properly performed.

While it is described in the above example that the value of the first bit varies, there is no limitation in the order of a bit which may be affected by noise.

As another example, the data packet DP transmitted to the data driving circuit 130 from the controller 140 may be transmitted to the data driving circuit 130 by being delayed due to the influence of noise. In this case, as the order of a bit constituting the data packet DP is delayed and thus the turn of the bit constituting the data packet DP is delayed, the display device 100 may abnormally operate or the control of the display device 100 may not be properly performed.

In particular, when the influence of noise is exerted on the display device 100 in which the current embedded point-to-point interface (EPI) standard is used, the influence of noise is removed by modifying the artwork of a printed circuit board (PCB) included in the display device 100 or by newly fabricating a printed circuit board (PCB). In this case, although noise may be removed, a problem may arise in that a printed circuit board (PCB) should be fabricated again, and a problem may arise in that the influence of noise by a surrounding environment in which the display device 100 is disposed cannot be removed.

Embodiments of the present disclosure may provide a display device and a driving method capable of automatically detecting noise. Embodiments of the present disclosure may provide a display device and a driving method capable of detecting noise in real time. Embodiments of the present disclosure may provide a display device and a driving method capable of low power consumption driving by detecting noise in real time. This will be described below in detail.

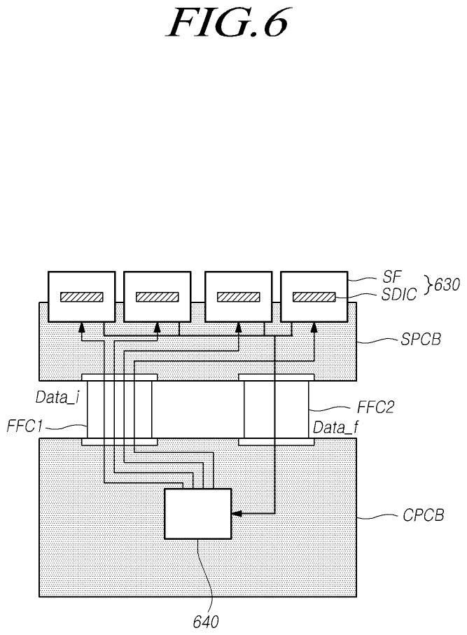

FIG. 6 is a diagram schematically illustrating a data driving circuit 630 and a controller 640 in accordance with embodiments of the present disclosure.

The data driving circuit 630 may supply a data voltage Vdata to a plurality of subpixels SP.

The controller 640 may transmit input data Data_i to the data driving circuit 630.

The data driving circuit 630 may be electrically connected to the controller 640. Since the data driving circuit 630 includes a plurality of source driving integrated circuits SDIC, the source driving integrated circuits SDIC may be electrically connected to the controller 640.

The data driving circuit 630 may be electrically connected to the controller 640 through cables FFC1 and FFC2 and printed circuit boards SPCB and CPCB. Each of the plurality of source driving integrated circuits SDIC included in the data driving circuit 630 may be connected to the controller 640 in one-to-one form. For example, a first source driving integrated circuit SDIC1 may be connected to the controller 640 through a first line, and a fourth source driving integrated circuit SDIC4 may be connected to the controller 640 through a fourth line.

As the data driving circuit 630 is electrically connected to the controller 640, the data driving circuit 630 and the controller 640 may exchange data.

The data driving circuit 630 may receive the input data Data_i transmitted through a first cable FFC1 from the controller 640. The input data Data_i may be image data DATA for displaying an image on a display panel 110 or test data Data_t different from the image data DATA.

After receiving the input data Data_i from the controller 640, the data driving circuit 630 may generate feedback data Data_f on the basis of the received input data Data_i.

The data driving circuit 630 may transmit the feedback data Data_f through a second cable FFC2 to the controller 640.

The controller 640 may compare the input data Data_i and the feedback data Data_f. The controller 640 may generate corrected data Data_e by comparing the input data Data_i and the feedback data Data_f.

When the controller 640 determines that the input data Data_i is affected by noise, the controller 640 may generate the corrected data Data_e by correcting the data packet DP, and may transmit the corrected data Data_e to the data driving circuit 630.

When the input data Data_i is the test data Data_t, the corrected data Data_e may be generated by blank-processing a specific bit in the input data Data_i by the controller 640.

When the input data Data_i is the test data Data_t, the corrected data Data_e may be generated by the controller 640 by correcting the bit value of a specific bit in the input data Data_i.

When the input data Data_i is the test data Data_t, the corrected data Data_e may be generated by the controller 640 by inserting bits corresponding to a signal delay into the image data DATA.

When the input data Data_i is the image data DATA, after the input data Data_i is transmitted to the data driving circuit 630 from the controller 640, the input data Data_i may be changed to the corrected data Data_e. The input data Data_i may be supplied to the data driving circuit 630 during an image data input time Ti for realizing an image on the display panel 110, and the corrected data Data_e may be supplied to the data driving circuit 630 during a corrected data input time Te that proceeds after the image data input time Ti.

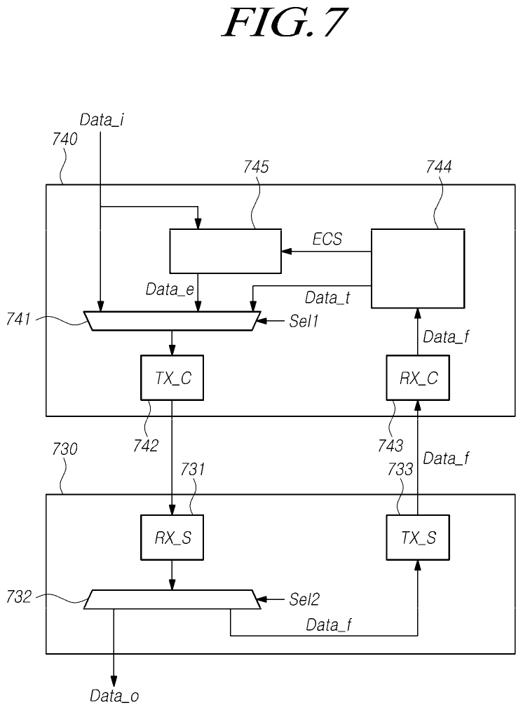

FIG. 7 is a circuit block diagram of a data driving circuit 730 and a controller 740 in accordance with embodiments of the present disclosure.

The controller 740 may include a multiplex(MUX) circuit 741, a first transmission circuit 742, a first reception circuit 743, a data error checking circuit unit 744, and a data correction circuit 745.

The MUX circuit 741 may receive a plurality of data and a data select signal Sel1. The MUX circuit 741 may select any one data among the plurality of data according to the data select signal Sel1, and may transmit the selected one data to the first transmission circuit 742. The MUX circuit 741 may receive input data Data_i, corrected data Data_e and test data Data_t. The MUX circuit 741 may be a multiplexer.

The first transmission circuit (TX_C) 742 may receive data from the MUX circuit 741. The first transmission circuit 742 may transmit received data to a second reception circuit 731 included in the data driving circuit 730. In other words, the controller 740 may transmit data to the data driving circuit 730.

The first reception circuit (RX_C) 743 may receive data from a second transmission circuit 733 included in the data driving circuit 730. The first reception circuit 743 may transmit the received data to the data error checking circuit unit 744. The data may be feedback data Data_f.

The data error checking circuit unit 744 may receive data from the first reception circuit 743, and the corresponding data may be the feedback data Data_f.

The data error checking circuit unit 744 may transmit the test data Data_t to the MUX circuit 741. Data generated by the data driving circuit 730 on the basis of the test data Data_t may be the feedback data Data_f received by the data error checking circuit unit 744.

The data error checking circuit unit 744 may compare the test data Data_t and the feedback data Data_f. The data error checking circuit unit 744 may compare the input data Data_i and the feedback data Data_f, and the input data Data_i may be image data DATA.

When the input data Data_i and the feedback data Data_f match each other, the data error checking circuit unit 744 may determine that there is no error in the feedback data Data_f. When the input data Data_i and the feedback data Data_f do not match each other, the data error checking circuit unit 744 may determine that an error exists in the feedback data Data_f.

During a data transmission process in which data is transmitted from the controller 740 to the data driving circuit 730, at least one bit among a plurality of bits included in the data may vary in its bit value due to noise. Such a variation in bit value may be referred to as occurrence of an error in the data. The data error checking circuit unit 744 may compare the test data Data_t and the feedback data Data_f, and may then determine whether an error has occurred in data. The data error checking circuit unit 744 may compare the input data Data_i and the feedback data Data_f, and may then determine whether an error has occurred in data.

When the data error checking circuit unit 744 determines that an error has occurred in data, the data error checking circuit unit 744 may transmit an error checking signal ECS to the data correction circuit 745.

The data correction circuit 745 may receive the error checking signal ECS from the data error checking circuit unit 744. Thereafter, the data correction circuit 745 may correct the bit value of at least one bit among a plurality of bits included in data, in consideration of noise to occur during a data transmission process. That is to say, the data correction circuit 745 may generate the corrected data Data_e in which the bit value of at least one bit among a plurality of bits included in data is corrected. The corrected data Data_e may be data obtained as the bit value of at least one bit of the test data Data_t or the input data Data_i is corrected.

After generating the corrected data Data_e, the data correction circuit 745 may transmit the corrected data Data_e to the MUX circuit 741.

The data driving circuit 730 may include the second reception circuit 731, a multi-output circuit unit 732 and the second transmission circuit 733.

The second reception circuit 731 may receive data from the first transmission circuit 742 included in the controller 740. The second reception circuit 731 may transmit the received data to the multi-output circuit unit 732.

The multi-output circuit unit 732 may receive data from the second reception circuit 731. The data may be the input data Data_i, the test data Data_t and the corrected data Data_e.

The multi-output circuit unit 732 may generate the feedback data Data_f on the basis of the received data.

The multi-output circuit unit 732 may receive a function select signal Sel2. The multi-output circuit unit 732 may select data to be outputted, according to the function select signal Sel2. In other words, according to the function select signal Sel2, the multi-output circuit unit 732 may output all or a part of a plurality of data.

The multi-output circuit unit 732 may be a demultiplexer, but is not limited thereto.

Data outputted from the multi-output circuit unit 732 may be transmitted to a driving circuit unit (not illustrated) included in the data driving circuit 730. The driving circuit unit may include a shift register (SR), a latch, a digital-to-analog converter (DAC) and an output buffer. The driving circuit unit may be configured by a circuit separate from the data driving circuit 730, but may be disposed inside the data driving circuit 730. Therefore, the data driving circuit 730 may include the shift register (SR), the latch, the digital-to-analog converter (DAC) and the output buffer.

Data outputted from the multi-output circuit unit 732 may be transmitted to the second transmission circuit 733, and the data may be the feedback data Data_f.

The second transmission circuit 733 may receive the feedback data Data_f from the multi-output circuit unit 732. The second transmission circuit 733 may transmit data to the first reception circuit unit 743 included in the controller 740, and the data may be the feedback data Data_f.

As described above, the feedback data Data_f may be transmitted from the data driving circuit 730 to the controller 740. The display device 100 may determine whether an error has occurred in data, using the feedback data Data_f transmitted from the data driving circuit 730 to the controller 740, and, when an error has occurred in the data, may generate the corrected data Data_e so that the corresponding error is corrected.

Embodiments of the present disclosure may provide a display device and a driving method capable of automatically detecting noise.

Embodiments of the present disclosure may provide a display device and a driving method capable of detecting noise in real time.

Embodiments of the present disclosure may provide a display device and a driving method capable of low power consumption driving by detecting noise in real time. Hereinafter, embodiments will be described in more detail.

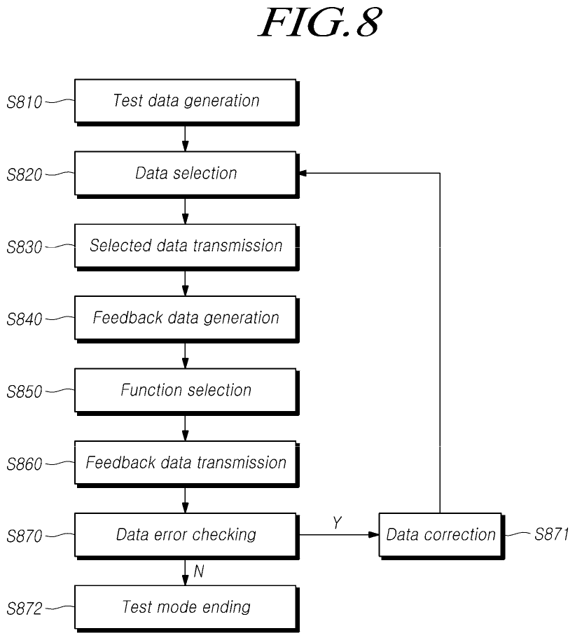

FIG. 8 is a flowchart in which a test mode in accordance with embodiments of the present disclosure is driven.

The test mode may include test data generation step S810, data selection step S820. selected data transmission step S830, feedback data generation step S840, function selection step S850, feedback data transmission step S860, data error checking step S870, data correction step S871, and test mode ending step S872.

The test data generation step S810 may be step in which the data error checking circuit unit 744 transmits the test data Data_t to the MUX circuit 741.

The data selection step S820 may be step in which the MUX circuit 741 selects any one data among a plurality of data according to the data select signal Sel1. In the data selection step S820, the MUX circuit 741 may select the test data Data_t.

The selected data transmission step S830 may be step in which the selected test data Data_t is transmitted from the MUX circuit 741 to the data driving circuit 730. The test data Data_t may be transmitted to the multi-output circuit unit 732 included in the data driving circuit 730.

The feedback data generation step S840 may be step in which the multi-output circuit unit 732 generates the feedback data Data_f on the basis of the received test data Data_t.

The function selection step S850 may be step in which the multi-output circuit unit 732 selects data to be outputted, according to the function select signal Sel2. The multi-output circuit unit 732 may transmit the feedback data Data_f to the second transmission circuit unit 733 under the control of the function select signal Sel2.

The feedback data transmission step S860 may be step in which the second transmission circuit unit 733 included in the data driving circuit 730 transmits the feedback data Data_f received from the multi-output circuit unit 732 to the controller 740. The feedback data Data_f transmitted to the controller 740 may be transmitted to the data error checking circuit unit 744 via the first reception circuit unit 743.

The data error checking step S870 may be step in which the data error checking circuit unit 744 compares the test data Data_t and the feedback data Data_f. When the data error checking circuit unit 744 determines that an error has occurred in data, the data error checking circuit unit 744 may transmit the error checking signal ECS to the data correction circuit 745. When an error is included in data, the data correction step S871 may proceed after the data error checking step S870, and when an error is not included in data, the test mode ending step S872 may proceed.

The data correction step S871 may be step in which the data correction circuit 745 corrects the bit value of at least one bit among a plurality of bits included in data, in consideration of noise to be generated during a data transmission process. The data correction circuit 745 may generate the corrected data Data_e in which the bit value of at least one bit among a plurality of bits included in data is corrected. Thereafter, the corrected data Data_e may be transmitted from the controller 740 to the data driving circuit 730.

The test mode ending step S872 may be step in which the test mode is ended and data outputted from the multi-output circuit unit 732 is transmitted to the driving circuit unit (not illustrated) included in the data driving circuit 730.

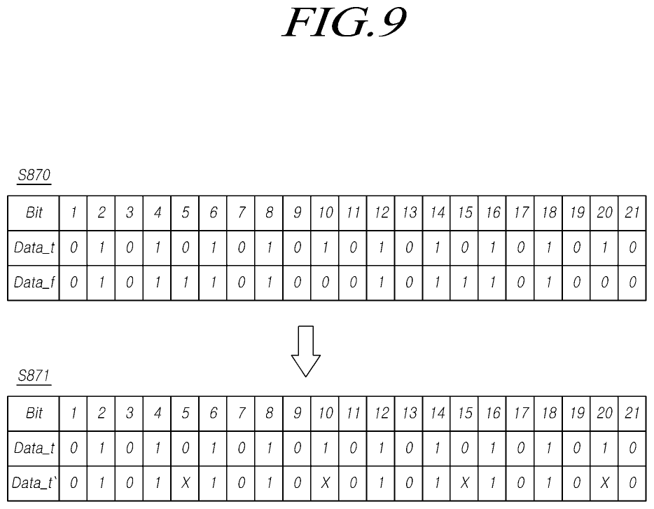

FIGS. 9 to 11 are diagrams for explaining the data error checking step S870 and the data correction step S871 performed in the test mode in accordance with the embodiments of the present disclosure.

Referring to FIG. 9, the test data Data_t and the feedback data Data_f which are compared by the data error checking circuit unit 744 in the data error checking step S870 may be seen.

Referring to FIG. 9, for example, each of the test data Data_t and the feedback data Data_f may be composed of 21 bits. The number of bits is for an illustrative purpose, and the number of bits included in data is not limited to 21. The test data Data_t may be composed of bit values of ‘0, 1, 0, 1, 0, 1, 0, 1, 0, 1, 0, 1, 0, 1, 0, 1, 0, 1, 0, 1, 0’ in order from a first bit to a 21st bit. The feedback data Data_f generated on the basis of the test data Data_t may be composed of bit values of ‘0, 1, 0, 1, 1, 1, 0, 1, 0, 0, 0, 1, 0, 1, 1, 1, 0, 1, 0, 0, 0’ in order from a first bit to a 21st bit.

By comparing the test data Data_t and the feedback data Data_f, it may be checked that fifth, 10th, 15th and 20th bits do not match each other. The reason why the mismatch occurs is because data is affected by noise during a data transmission process. The mismatch may occur with a specific pattern, and this may be referred to as “fixed errors.”

Referring to FIG. 9, it may be checked that, in the data correction step S871, the data correction circuit 745 corrects some bits among the plurality of bits included in the test data Data_t. in consideration of noise to be generated during a data transmission process.

Referring to FIG. 9, it may be checked that, since fixed errors occur in the fifth, 10th, 15th and 20th bits of the test data Data_t, test data Data_t′ is generated by blank-processing the fifth, 10th, 15th and 20th bits of the test data Data_t. The blank processing may be a method of not transmitting a specific bit value. The blank processing may be performed by delaying and transmitting data by intentionally giving a delay.

Because fixed errors may occur in the fifth, 10th, 15th and 20th bits due to the influence of noise even after the test mode proceeds, in the data correction step S871, the corrected data Data_e may be generated by correcting the fifth, 10th, 15th and 20th bits of the input data Data_i.

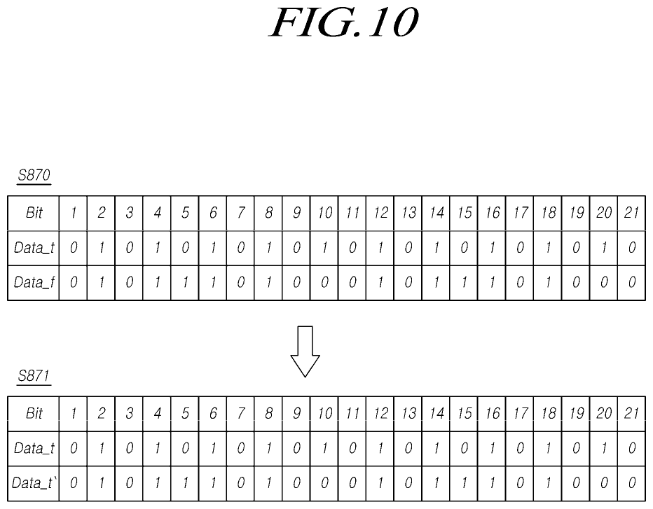

Referring to FIG. 10, the test data Data_t and the feedback data Data_f which are compared by the data error checking circuit unit 744 in the data error checking step S870 may be seen.

Referring to FIG. 10, for example, each of the test data Data_t and the feedback data Data_f may be composed of 21 bits. The number of bits is for an illustrative purpose, and the number of bits included in data is not limited to 21. The test data Data_t may be composed of bit values of ‘0, 1, 0, 1, 0, 1, 0, 1, 0, 1, 0, 1, 0, 1, 0, 1, 0, 1, 0, 1, 0’ in order from a first bit to a 21st bit. The feedback data Data_f generated on the basis of the test data Data_t may be composed of bit values of ‘0, 1, 0, 1, 1, 1, 0, 1, 0, 0, 0, 1, 0, 1, 1, 1, 0, 1, 0, 0, 0’ in order from a first bit to a 21st bit.

By comparing the test data Data_t and the feedback data Data_f, it may be checked that fifth, 10th, 15th and 20th bits do not match each other. The reason why the mismatch occurs is because data is affected by noise during a data transmission process. The mismatch may occur with a specific pattern, and thus, this may be referred to as “fixed errors.”

Referring to FIG. 10, it may be checked that, in the data correction step S871, the data correction circuit 745 corrects some bits among the plurality of bits included in the test data Data_t. in consideration of noise to be generated during a data transmission process.

Referring to FIG. 10, it may be checked that, since fixed errors occur in the fifth, 10th, 15th and 20th bits of the test data Data_t, test data Data_t′ is generated by correcting the bit values of the fifth, 10th, 15th and 20th bits of the test data Data_t to opposite bit values. For example, the fifth and 15th bits which have the bit values of 0 may be corrected to the bit values of 1, and the 10th and 20th bits which have the bit values of 1 may be corrected to the bit values of 0.

Because fixed errors may occur in the fifth, 10th, 15th and 20th bits due to the influence of noise even after the test mode proceeds, in the data correction step S871, the corrected data Data_e may be generated by correcting the fifth, 10th, 15th and 20th bits of the input data Data_i.

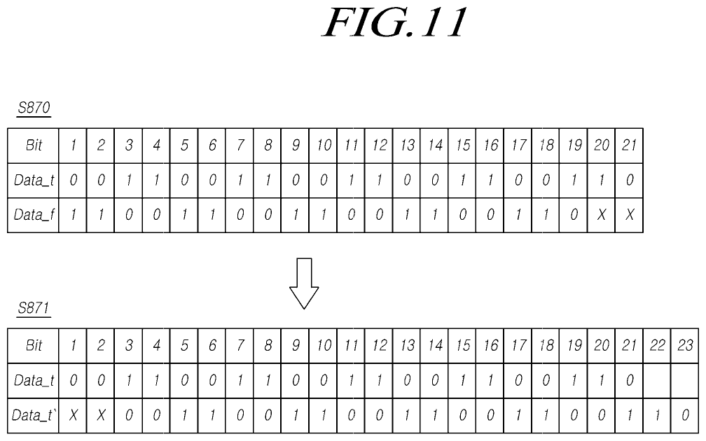

Referring to FIG. 11, the test data Data_t and the feedback data Data_f which are compared by the data error checking circuit unit 744 in the data error checking step S870 may be seen.

Referring to FIG. 11, for example, each of the test data Data_t and the feedback data Data_f may be composed of 21 bits. The number of bits is for an illustrative purpose, and the number of bits included in data is not limited to 21. The test data Data_t may be composed of bit values of ‘0, 0, 1, 1, 0, 0, 1, 1, 0, 0, 1, 1, 0, 0, 1, 1, 0, 0, 1, 1, 0’ in order from a first bit to a 21st bit. The feedback data Data_f generated on the basis of the test data Data_t may be composed of bit values of ‘1, 1, 0, 0, 1, 1, 0, 0, 1, 1, 0, 0, 1, 1, 0, 0, 1, 1, 0, x, x’ in order from a first bit to a 21st bit. A bit value of x may mean that a bit value is not inputted to a specific bit. Namely, bit values may not be inputted to 20th and 21st bits of the feedback data Data_f.

By comparing the test data Data_t and the feedback data Data_f, it may be checked that all the bit values do not match each other and the order of the bit values is constantly shifted. The reason why the mismatch occurs may be because data is affected by noise during a data transmission process and delay occurs due to noise during the data transmission process.

Referring to FIG. 11, it may be checked that, in the data correction step S871, the data correction circuit 745 corrects some bits among the plurality of bits included in the test data Data_t. in consideration of noise to be generated during a data transmission process.

Referring to FIG. 11, it may be checked that, since delay occurs during a data transmission process, in order to change order of bits shifted according to the delay, test data Data_t′ is generated by not inputting first and second bit values in the test data Data_t. The test data Data t′ may be composed of bit values of ‘x, x, 0, 0, 1, 1, 0, 0, 1, 1, 0, 0, 1, 1, 0, 0, 1, 1, 0, 0, 1, 1, 0’ in order from a first bit to a 23rd bit.

Since a specific delay may occur during a data transmission process even after the test mode proceeds, in the data correction step S871, the corrected data Data_e may be generated by correcting bit values by the specific delay in the input data Data_i.

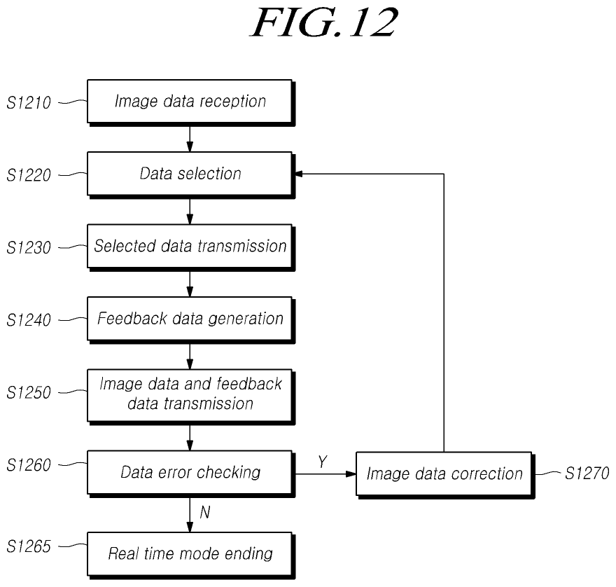

FIG. 12 is a flowchart in which a real time mode in accordance with embodiments of the present disclosure is driven.

The real time mode may include image data reception step S1210, data selection step S1220, selected data transmission step S1230, feedback data generation step S1240, image data and feedback data transmission step S1250, data error checking step S1260, image data correction step S1270, and real time mode ending step S1265.

The image data reception step S1210 may be step in which the MUX circuit 741 receives the input data Data_i. The input data Data_i may be the image data DATA. Hereinafter, for the sake of convenience in explanation, it is assumed that the input data Data_i is the image data DATA.

The data selection step S1220 may be step in which the MUX circuit 741 selects any one data among a plurality of data according to the data select signal Sel1. In the data selection step S1220, the MUX circuit 741 may select the input data Data_i or the corrected data Data_c.

The selected data transmission step S1230 may be step in which selected data is transmitted from the MUX circuit 741 to the data driving circuit 730. The data may be transmitted to the multi-output circuit unit 732 included in the data driving circuit 730.

The feedback data generation step S1240 may be step in which the multi-output circuit unit 732 generates the feedback data Data_f on the basis of the received data. The multi-output circuit unit 732 may receive the input data Data_i and generate the feedback data Data_f on the basis of the input data Data_i.

The image data and feedback data transmission step S1250 may be step in which the multi-output circuit unit 732 transmits the image data DATA and the feedback data Data_f to the outside. The image data DATA may be transmitted to the driving circuit unit (not illustrated), and the feedback data Data_f may be transmitted to the controller 740.

The data error checking step S1260 may be step in which the data error checking circuit unit 744 compares the image data DATA and the feedback data Data_f. When the data error checking circuit unit 744 determines that an error has occurred in data, the data error checking circuit 744 may transmit the error checking signal ECS to the data correction circuit 745. When an error is included in data, the image data correction step S1270 may proceed after the data error checking step S1260, and when an error is not included in data, the method may advance to real time mode ending step S1265 and the image data DATA on the basis of which the feedback data Data_f is generated may not be corrected.

The image data correction step S1270 may be step in which the data correction circuit 745 corrects the bit value of at least one bit among a plurality of bits included in data, in consideration of noise to be generated during a data transmission process. The data correction circuit 745 may generate the corrected data Data_e in which the bit value of at least one bit among a plurality of bits included in data is corrected. Thereafter, the corrected data Data_e may be transmitted from the controller 740 to the data driving circuit 730.

Description of an example of a specific operation is as follows. It may be assumed that there is an error in first input data Data_i1. In the image data and feedback data transmission step S1250, the first input data Data_i1 may be transmitted to the driving circuit (not illustrated). The first input data Data_i1 may be converted into analog voltage values depending on a driving timing of the display device 100, and may be outputted to data lines. Since first feedback data Data_f1 generated on the basis of the first input data Data_i1 will not be the same as the first input data Data_i1, the data correction circuit 745 may generate first corrected data Data_e1 by correcting the first input data Data_i1. Thereafter, after the first corrected data Data_e1 is transmitted to the data driving circuit 730, the first input data Data_i1 may be replaced with the first corrected data Data_e1. Accordingly, the display device 100 may be normally controlled, and may achieve a desired luminance.

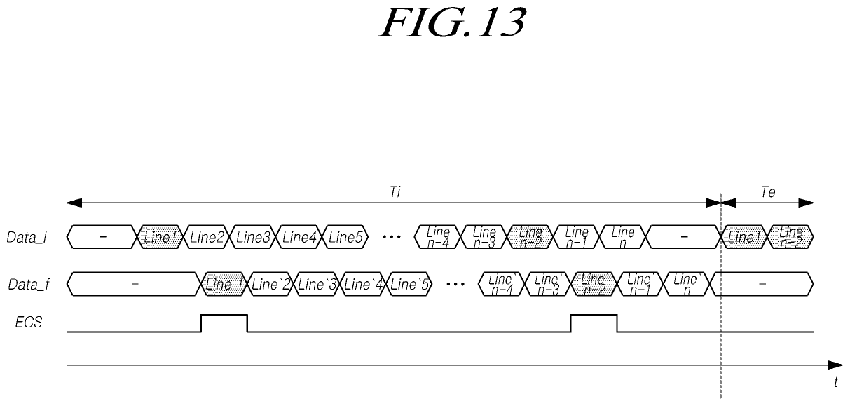

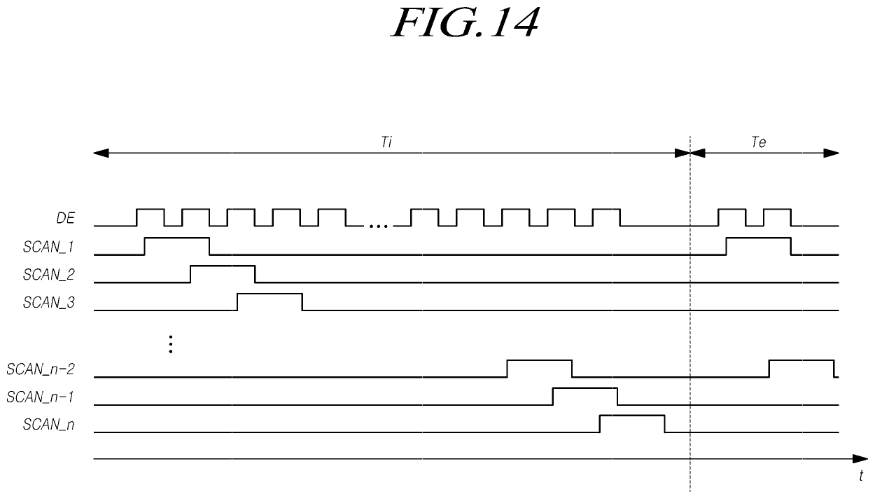

FIGS. 13 and 14 are diagrams for explaining driving of the real time mode in accordance with the embodiments of the present disclosure.

The real time mode may be a mode in which an error included in data is detected during a time for the display device 100 to implement an image through the display panel 110.

The real time mode may proceed regardless of the test mode. Alternatively, the real time mode may proceed after the test mode proceeds.

Referring to FIG. 13, driving of the display device 100 may be divided into an image data input time Ti and a corrected data input time Te.

The image data input time Ti may be a time during which image data DATA for implementing an image is transmitted from the controller 740 to the data driving circuit 730. The image data DATA may be the input data Data_i.

The input data Data_i may include a plurality of line data packets Line. The number of the plurality of gate lines GL may be n, and scan signals SCAN may be sequentially supplied to the n number of gate lines GL, respectively. The plurality of line data packets Line may be sequentially transmitted from the controller 740 to the data driving circuit 730 according to the scan signals SCAN.

For example, when a first scan signal SCAN_1 is a turn-on signal, a first line data packet Line 1 may be transmitted, and when a second scan signal SCAN_2 is a turn-on signal, a second line data packet Line 2 may be transmitted. As this process repeatedly proceeds, when an nth scan signal SCAN_n is a turn-on signal, an nth line data packet Line n may be transmitted.

Since the data driving circuit 730 may generate the feedback data Data_f on the basis of the input data Data_i, after receiving the line data packet Line, the data driving circuit 730 may generate a line feedback data packet Line′ on the basis of the line data packet Line. For the sake of convenience in explanation, the line feedback data packet Line′ may be referred to as the feedback data Data_f.

After the feedback data Data_f is transmitted from the data driving circuit 730 to the controller 740, the data error checking circuit 744 included in the controller 740 may compare the input data Data_i and the feedback data Data_f.

After comparing the input data Data_i and the feedback data Data_f, the data error checking circuit 744 may determine whether an error is included in the input data Data_i. When the data error checking circuit 744 determines that an error is included in the input data Data_i, the data error checking circuit 744 may transmit the error checking signal ECS to the data correction circuit 745. The error checking signal ECS may be a signal of a high level, but is not limited thereto.

For example, as the data error checking circuit 744 compares the input data Data_i and the feedback data Data_f, errors may be included in the first line data packet Line 1 which is transmitted when the first scan signal SCAN_1 is a turn-on signal and an (n-2)th line data packet Line n-2 which is transmitted when an (n-2)th scan signal SCAN_n-2 is a turn-on signal. In this case, the data error checking circuit 744 may transmit the error checking signal ECS for the first line data packet Line 1 and the error checking signal ECS for the (n-2)th line data packet Line n-2 to the data correction circuit 745.

Thereafter, the data correction circuit 745 may receive the input data Data_i again, correct a corresponding error and generate the corrected data Data_c.

When an error is included in the input data Data_i, the corresponding input data Data_i may be converted into an analog voltage, and the converted analog voltage may be supplied to the subpixel SP. Since the corresponding subpixel SP is supplied with an error voltage converted from the input data Data_i including the error, the corresponding subpixel SP may be referred to as an error subpixel SPe. Since the error voltage has been supplied to the error subpixel SPe, a normal voltage converted from the corrected data Data_e in which the error is corrected should be supplied.

After the image data input time Ti ends, the corrected data input time Te may proceed. In order to supply the normal voltage converted from the corrected data Data_e to the error subpixel SPe during the corrected data input time Te, a turn-on gate signal may be supplied to a specific gate line GLe which is electrically connected to the error subpixel SPe. Because the turn-on gate signal should be supplied to the specific gate line GLe during the corrected data input time Te, information on the specific gate line GLe may be stored in a memory (not illustrated) during the image data input time Ti. The memory may be included in the controller 740.

The corrected data input time Te may be a time during which the corrected data Data_e generated by the data correction circuit 745 is transmitted from the controller 740 to the data driving circuit 730.

For example, errors may be included in the first line data packet Line 1 and the (n-2)th line data packet Line n-2.

The corrected data Data_e for the first line data packet Line 1 may be transmitted from the controller 740 to the data driving circuit 730. In this case, the existing input data Data_i may be changed by the corrected data Data_e. When the first scan signal SCAN_1 is a turn-on signal, the corrected data Data_e may be converted into an analog voltage and the converted analog voltage may be supplied to the display panel 110. Information on a gate line to which the scan signal SCAN being a turn-on signal is to be supplied during the corrected data input time Te is stored in a memory (not illustrated).

Referring to FIG. 14, the first scan signal SCAN_1 being a turn-on signal may be supplied to a first gate line GL1 during the corrected data input time Te on the basis of the information stored in the memory. Subpixels SP which are electrically connected to the first gate line GL1 are in a state in which the subpixels SP can be supplied with the data voltage Vdata. That is to say, a normal voltage obtained by converting the corrected data Data_e into an analog form may be supplied to the subpixels SP which are electrically connected to the first gate line GL1.

For example, the data voltage Vdata may be supplied again to all of the subpixels SP which are electrically connected to the first gate line GL1. While the normal voltage obtained by converting the corrected data Data_e into an analog form is supplied to the error subpixel SPe, at the same time, a voltage obtained by converting the input data Data_i not including an error into an analog form may be supplied again to a subpixel SP.

As another example, a normal voltage obtained by converting the corrected data Data_e into an analog form may be supplied to only the error subpixel SPe among the subpixels SP which are electrically connected to the first gate line GL1. The normal voltage obtained by converting the corrected data Data_e into an analog form may be supplied to only a specific data line DL.

The corrected data Data_e for the (n-2)th line data packet Line n-2 may be transmitted from the controller 740 to the data driving circuit 730. In this case, the existing input data Data_i may be changed by the corrected data Data_e. When the (n-2)th scan signal SCAN_n-2 is a turn-on signal, the corrected data Data_e may be converted into an analog voltage and the converted analog voltage may be supplied to the display panel 110. Information on a gate line to which the scan signal SCAN being a turn-on signal is to be supplied during the corrected data input time Te is stored in the memory (not illustrated).

Referring to FIG. 14, the (n-2)th scan signal SCAN_n-2 being a turn-on signal may be supplied to an (n-2)th gate line GLn-2 during the corrected data input time Te on the basis of the information stored in the memory. Subpixels SP which are electrically connected to the (n-2)th gate line GLn-2 are in a state in which the subpixels SP can be supplied with the data voltage Vdata. That is to say, a normal voltage obtained by converting the corrected data Data_e into an analog form may be supplied to the subpixels SP which are electrically connected to the (n-2)th gate line GLn-2.

For example, the data voltage Vdata may be supplied again to all of the subpixels SP which are electrically connected to the (n-2)th gate line GLn-2. While the normal voltage obtained by converting the corrected data Data_e into an analog form is supplied to the error subpixel SPe, at the same time, a voltage obtained by converting the input data Data_i not including an error into an analog form may be supplied again to a subpixel SP.

As another example, a normal voltage obtained by converting the corrected data Data_e into an analog form may be supplied to only the error subpixel SPe among the subpixels SP which are electrically connected to the (n-2)th gate line GLn-2. The normal voltage obtained by converting the corrected data Data_e into an analog form may be supplied to only a specific data line DL.

Referring to FIG. 14, a data enable signal DE may be supplied during the image data input time Ti and the corrected data input time Te.

Referring to FIG. 14, during the image data input time Ti, the data enable signal DE may be supplied to the data driving circuit 730 in synchronization with a clock signal, and the scan signal SCAN being a turn-on signal may be supplied to a gate line GL in conformity with the data enable signal DE.

Referring to FIG. 14, during the corrected data input time Te, the data enable signals DE may be supplied to the data driving circuit 730 by the number of error checking signals ECS generated by the data error checking circuit 744. Information on the number of error checking signals ECS and gate lines GL to which turn-on signals are to be supplied is stored in a memory (not illustrated).

Referring to FIG. 14, for example, when the error check signal ECS is generated twice, the data enable signal DE may be supplied twice. When the first scan signal SCAN_1 is a turn-on signal, the corrected data Data_e for the first line data packet Line 1 may be converted into an analog voltage and the converted analog voltage may be supplied to the display panel 110. When the (n-2)th scan signal SCAN_n-2 is a turn-on signal, the corrected data Data_e for the (n-2)th line data packet Line n-2 may be converted into an analog voltage and the converted analog voltage may be supplied to the display panel 110.

In other words, as the existing input data Data_i is changed to the corrected data Data_e, data affected by noise may be corrected, and thus, the display device 100 may be normally controlled.

The above-described embodiments of the present disclosure may provide a display device and a driving method capable of automatically detecting noise.

The embodiments of the present disclosure may provide a display device and a driving method capable of detecting noise in real time.

The embodiments of the present disclosure may provide a display device and a driving method capable of low power consumption driving by detecting noise in real time.

A brief description of the embodiments of the present disclosure described above is as follows.

Embodiments of the present disclosure may provide a display device including a display panel including a plurality of subpixels which are electrically connected to a plurality of data lines and a plurality of gate lines, a data driving circuit for supplying data voltages to the plurality of subpixels, and a controller configured to transmit input data to the data driving circuit, wherein the data driving circuit transmits feedback data generated on the basis of the input data to the controller, and the controller generates corrected data by comparing the input data and the feedback data.

The input data may be image data for displaying an image on the display panel or test data different from the image data.

The input data may be the test data, and the corrected data may be generated by blank-processing a specific bit in the input data.

The input data may be the test data, and the corrected data may be generated by correcting a bit value of a specific bit in the input data.

The input data may be the test data, the feedback data may not match the input data due to a signal delay, and the corrected data may be generated by inserting bits corresponding to the signal delay into the image data.

The input data may be the image data, and after the input data is transmitted from the controller to the data driving circuit, the input data may be changed to the corrected data.

The input data may be supplied to the data driving circuit during an image data input time for implementing the image on the display panel, and the corrected data may be supplied to the data driving circuit during a corrected data input time that proceeds after the image data input time.

The controller may include a MUX circuit configured to receive the input data, a first transmission circuit configured to transmit the input data to the data driving circuit, a first reception circuit configured to receive the feedback data from the data driving circuit, a data error checking circuit configured to compare the input data and the feedback data, and a data correction circuit configured to, when receiving from the data error checking circuit an error checking signal indicating that an error exists in the input data, output the corrected data in which the error in the input data is corrected.

The MUX circuit may receive a data select signal, and may transmit the input data or the corrected data to the first transmission circuit according to the data select signal.

When the input data and the feedback data match each other, the data error checking circuit may determine that no error exists in the feedback data, and when the input data and the feedback data do not match each other, the data error checking circuit may determine that the error exists in the feedback data.

The data driving circuit may include a second reception circuit configured to receive the input data from the first transmission circuit, a second transmission circuit configured to transmit the feedback data to the first reception circuit, and a multi-output circuit configured to receive the input data from the second reception circuit and transmit the feedback data to the second transmission circuit.

The multi-output circuit may receive a function select signal, and may select data to output according to the function select signal.

The data driving circuit may include a digital-to-analog converter which receives the corrected data and converts the corrected data into an analog voltage.

Embodiments of the present disclosure may provide a method for driving a display device, including selected data transmission step in which a controller for controlling a data driving circuit transmits input data to the data driving circuit, feedback data generation step in which the data driving circuit generates feedback data on the basis of the input data, feedback data transmission step in which the data driving circuit transmits the feedback data to the controller, data error checking step in which the controller compares the input data and the feedback data, and data correction step in which, when determining that an error has occurred in the feedback data, the controller generates corrected data by correcting the input data.

The input data may be image data for displaying an image on a display panel or test data different from the image data.

The input data may be the test data, and the corrected data may be generated by blank-processing a specific bit in the input data.

The input data may be the test data, and the corrected data may be generated by correcting a bit value of a specific bit in the input data.

The input data may be the test data, the feedback data may not match the input data due to a signal delay, and the corrected data may be generated by inserting bits corresponding to the signal delay into the image data.

The input data may be the image data, and after the input data is transmitted from the controller to the data driving circuit, the input data may be changed to the corrected data.

The input data may be supplied to the data driving circuit during an image data input time for implementing an image on the display panel, and the corrected data may be supplied to the data driving circuit during a corrected data input time that proceeds after the image data input time.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A display device comprising:
a display panel including:
a plurality of data lines;
a plurality of gate lines; and
a plurality of subpixels which are electrically connected to the plurality of data lines and the plurality of gate lines;
a data driving circuit for supplying data voltages to the plurality of subpixels; and
a controller configured to transmit input data to the data driving circuit,
wherein the data driving circuit transmits feedback data generated based on the input data to the controller, and
wherein the controller generates corrected data by comparing the input data and the feedback data.

2. The display device of claim 1, wherein the input data is image data for displaying an image on the display panel or test data different from the image data.

3. The display device of claim 2, wherein
the input data is the test data, and
the corrected data is generated by blank-processing a specific bit in the input data.

4. The display device of claim 2, wherein
the input data is the test data, and
the corrected data is generated by correcting a bit value of a specific bit in the input data.

5. The display device of claim 2, wherein
the input data is the test data,
the feedback data does not match the input data due to a signal delay, and
the corrected data is generated by inserting bits corresponding to the signal delay into the image data.

6. The display device of claim 2, wherein
the input data is the image data, and
after the input data is transmitted from the controller to the data driving circuit, the input data is changed to the corrected data.

7. The display device of claim 6, wherein
the input data is supplied to the data driving circuit during an image data input time for implementing the image on the display panel, and
the corrected data is supplied to the data driving circuit during a corrected data input time that proceeds after the image data input time.

8. The display device of claim 1, wherein the controller comprises:
a multiplex circuit configured to receive the input data;
a first transmission circuit configured to transmit the input data to the data driving circuit;
a first reception circuit configured to receive the feedback data from the data driving circuit;
a data error checking circuit configured to compare the input data and the feedback data; and
a data correction circuit configured to, when receiving from the data error checking circuit an error checking signal indicating that an error exists in the input data, output the corrected data in which the error in the input data is corrected.

9. The display device of claim 8, wherein the multiplex circuit receives a data select signal, and transmits the input data or the corrected data to the first transmission circuit according to the data select signal.

10. The display device of claim 8, wherein
when the input data and the feedback data match each other, the data error checking circuit determines that no error exists in the feedback data, and
when the input data and the feedback data do not match each other, the data error checking circuit determines that the error exists in the feedback data.

11. The display device of claim 8, wherein the data driving circuit comprises:
a second reception circuit configured to receive the input data from the first transmission circuit;
a second transmission circuit configured to transmit the feedback data to the first reception circuit; and
a multi-output circuit unit configured to receive the input data from the second reception circuit and transmit the feedback data to the second transmission circuit.

12. The display device of claim 11, wherein the multi-output circuit receives a function select signal, and selects data to be output according to the function select signal.

13. The display device of claim 1, wherein the data driving circuit includes a digital-to-analog converter which receives the corrected data and converts the corrected data into an analog voltage.

14. A method for driving a display device, comprising:
transmitting, by a controller, input data to a data driving circuit;
generating feedback data, by the data driving circuit, based on the input data;
transmitting, by the data driving circuit, the feedback data to the controller;
comparing, by the controller, the input data and the feedback data; and
generating, by the controller, corrected data by correcting the input data when determining that an error has occurred in the feedback data.

15. The method of claim 14, wherein the input data is image data for displaying an image on a display panel or test data different from the image data.

16. The method of claim 15, comprising:
generating the corrected data by blank-processing a specific bit in the input data, and
wherein the input data is the test data.

17. The method of claim 15, comprising:
generating the corrected data by correcting a bit value of a specific bit in the input data, and
wherein the input data is the test data.

18. The method of claim 15, comprising:
generating the corrected data by inserting bits corresponding to the signal delay into the image data,
wherein the input data is the test data, and
wherein the feedback data does not match the input data due to a signal delay.

19. The method of claim 15, comprising:
after the input data is transmitted from the controller to the data driving circuit, changing the input data to the corrected data,
wherein the input data is the image data.

20. The method of claim 19, comprising:
supplying the input data to the data driving circuit during an image data input time for implementing an image on the display panel, and
supplying the corrected data to the data driving circuit during a corrected data input time that proceeds after the image data input time.
